(19) United States
(12) Patent Application Publication
(10) Pub. No.: US 2026/0349082 A1
(43) Pub. Date: Nov. 5, 2026

(54) LIDAR AND VEHICLE

(71) Applicant: TENSOR AI SINGAPORE PTE. LTD., SINGAPORE (SG)

(72) Inventors: Puxi Hu, Shenzhen (CN); Yanan Zhi, Shenzhen (CN); Jianxiong Xiao, Shenzhen (CN); Yizhou Shan, Shenzhen (CN); Xuhui Tao, Shenzhen (CN); Xi Zou, Shenzhen (CN); Zhenkun Wang, Shenzhen (CN); Xin Wang, Shenzhen (CN)

(73) Assignee: TENSOR AI SINGAPORE PTE. LTD., SINGAPORE (SG)

(21) Appl. No.: 19/193,990

(22) Filed: Apr. 30, 2025

(51) Int. Cl. G01S 7/481

(52) U.S. Cl. CPC G01S 7/4817; G01S 7/4813

(57) ABSTRACT

The disclosure provides a LiDAR device, including: a housing, including a laser transceiver assembly; a host module, and a scanning module, comprising a prism rotating about a first axis; wherein both the host module and the scanning module are disposed within the housing, the laser emitted by the laser transceiver assembly is incident to the prism along a second axis, the laser is reflected and emitted out of the housing by the prism, forming two detection fields of view, the first axis and the second axis are perpendicular to each other, and the two detection fields of view are symmetrical about the second axis. The disclosure also provides a vehicle with the LiDAR device,

### TECHNICAL FIELD

The disclosure relates to the technical field of laser radar, and in particular to a laser radar and a vehicle.

### BACKGROUND

Nowadays, typical representatives of automotive FMCW (Frequency Modulated Continuous Wave) hybrid solid-state LiDAR include Innovusion LiDAR and Luminar LiDAR, featuring a field of view (FOV) of 120°×25° and a maximum angular resolution of 0.06°×0.06° in the staring region. Existing implementations achieve two-dimensional scanning for hybrid solid-state LiDAR systems through a one-dimensional rotating polygonal prism scanning in one axis and a one-dimensional rotating scanning optical device operating in the orthogonal axis. While this scanning methodology enables specific FOV coverage in both vertical and horizontal directions, the rotating polygonal prism utilized for horizontal scanning inherently creates substantial blind zones. In practical deployment scenarios, as FMCW radars are forward-mounted and their horizontal FOV is universally constrained below 135°, they fail to detect the vehicle's lateral flanks and rear fields of view, resulting in undetected blind zones that pose significant safety risks for high-level autonomous vehicles.

### SUMMARY

In view of this, it is necessary to provide a laser radar and a vehicle that can achieve a larger horizontal field of view to reduce the blind areas of the vehicle.

In a first aspect, the embodiment of the disclosure provides a laser radar. The LiDAR device, including: a housing, including a laser transceiver assembly; a host module, and a scanning module, comprising a prism rotating about a first axis; wherein both the host module and the scanning module are disposed within the housing, the laser emitted by the laser transceiver assembly is incident to the prism along a second axis, the laser is reflected and emitted out of the housing by the prism, forming two detection fields of view, the first axis and the second axis are perpendicular to each other, and the two detection fields of view are symmetrical about the second axis.

In a second aspect, the embodiment of the disclosure provides a vehicle. The vehicle includes a body and the laser radar as described above. The laser radar is disposed on the body.

In the above laser radar and vehicle, the laser radar forms two detection fields of view through the rotation of the prism. The two detection fields of view jointly form the detection field of view of the laser radar. Based on the rotational scanning of a one-dimensional double-sided prism and the reciprocating oscillation of a one-dimensional oscillating mirror, the horizontal field of view of the detection field of view can reach 320°, and the vertical field of view of the detection field of view can reach 25°, so that the field of view of the laser radar's detection field of view reaches 320°×25°, featuring a large field of view. When applied in the field of autonomous driving, the laser radar is installed on the vehicle and can detect a large area around the vehicle, making the vehicle's field of view blind area smaller and thus increasing the safety factor of autonomous driving.

### BRIEF DESCRIPTION OF THE DRAWINGS

To more clearly illustrate the technical solutions in the embodiments of the disclosure or in the prior art, the drawings to be used in the description of the embodiments or the prior art will be briefly introduced below. It is apparent that the drawings described below are merely some embodiments of the disclosure. For those skilled in the art, other drawings can be obtained based on the structures shown in these drawings without creative efforts.

FIG. 1 is a perspective view of a laser radar in accordance with an embodiment.

FIG. 2 is an exploded view of a laser radar in accordance with an embodiment.

FIG. 3 is a schematic view of the internal structure of a laser radar in accordance with an embodiment.

FIG. 4 is an internal view of a laser radar in accordance with an embodiment.

FIG. 5 is a perspective view of a host module of the laser radar shown in FIG. 1.

FIG. 6 is a perspective view of a scanning module of the laser radar shown in FIG. 1.

FIG. 7 is a schematic system diagram of a laser radar in accordance with an embodiment.

FIG. 8 is a schematic view of a vehicle in accordance with an embodiment.

The realization of the objectives, functional features, and advantages of the disclosure will be further described below with reference to the embodiments and the drawings.

### DETAILED DESCRIPTION OF THE EMBODIMENTS

In order to make the purpose, technical solution, and advantages of this application clearer and clearer, the following will provide further detailed explanations of this application in conjunction with the accompanying drawings and embodiments. It should be understood that the specific embodiments described here are only intended to explain the present application and are not intended to limit the present application. Based on the embodiments in this application, all other embodiments obtained by ordinary technical personnel in this field without creative labor fall within the scope of protection of this application.

The terms “first,” “second,” “third,” “fourth,” etc. (if present) in the specification, claims, and accompanying drawings of the present application are used to distinguish similar planning objects and are not necessarily used to describe a specific sequence or order. It should be understood that such terms, when used, may be interchangeable under appropriate circumstances. In other words, the described embodiments may be implemented in an order other than that illustrated or described herein. Furthermore, the terms “include” and “have” and any variations thereof may also encompass additional content. For example, a process, method, system, product, or device comprising a series of steps or units is not limited to only those steps or units clearly listed but may include other steps or units not clearly listed or inherent to those processes, methods, products, or device.

It is important to note that the descriptions involving “first,” “second,” etc., in the present application are solely for descriptive purposes and should not be understood as indicating or implying their relative importance or implicitly specifying the number of indicated technical features. Therefore, features qualified by “first,” “second,” etc., may explicitly or implicitly include one or more of such features. In addition, the technical solutions among the various embodiments may be combined with each other, but this must be based on the ability of ordinary skilled artisans in the field to achieve such combinations. When the combination of technical solutions contradicts each other or cannot be implemented, such combinations should be deemed non-existent and not within the scope of protection claimed in the present application.

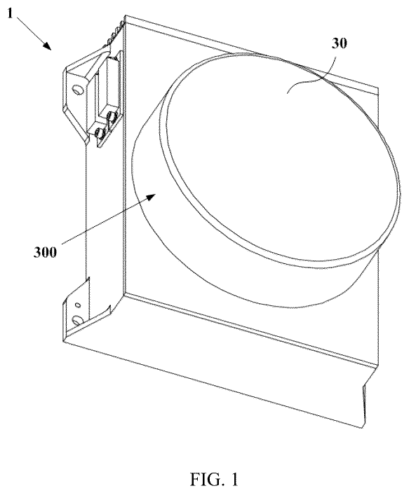

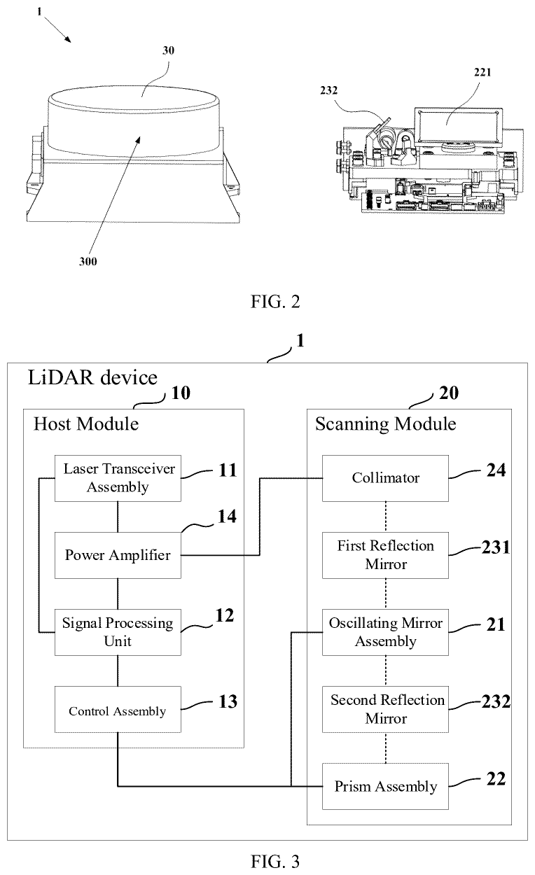

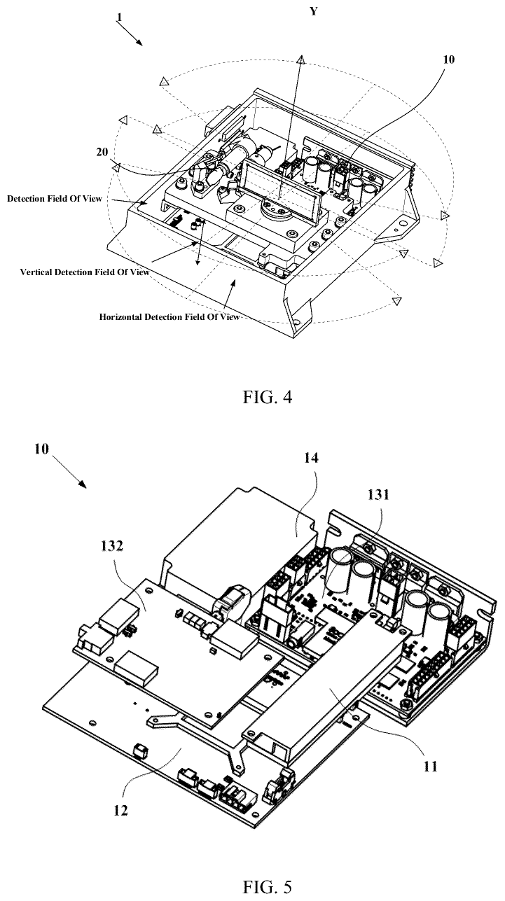

Referring to FIGS. 1 to 5 and 7. FIG. 1 is a perspective view of a laser radar in accordance with an embodiment. FIG. 2 is an exploded view of a laser radar in accordance with an embodiment. FIG. 3 is a schematic view of the internal structure of a laser radar in accordance with an embodiment. FIG. 4 is an internal view of a laser radar in accordance with an embodiment. FIG. 5 is a perspective view of a host module of the laser radar shown in FIG. 1. FIG. 7 is a schematic system diagram of a laser radar in accordance with an embodiment. The LiDAR device 1 is a hybrid solid-state laser radar, applied in the field of autonomous driving, and used to detect the surrounding environment of autonomous vehicles. In some feasible embodiments, the LiDAR device 1 may also be applied in fields such as intelligent robots and industrial applications.

The LiDAR device 1 includes a housing 30, a host module 10, and a scanning module 20. The host module 10 and the scanning module 20 are electrically connected and both disposed in the housing 30. Among them, the host module 10 and the scanning module 20 are connected by optical fibers. In this embodiment, the housing 30 is provided with a window 300, and the scanning module 20 is disposed opposite to the window 300.

The host module 10 includes a laser transceiver assembly 11, a signal processing unit 12, a control assembly 13, and a power amplifier 14. The signal processing unit 12 is electrically connected to the laser transceiver assembly 11, the control assembly 13, and the power amplifier 14 respectively. The power amplifier 14 is electrically connected to the laser transceiver assembly 11 and the scanning module 20 respectively. In this embodiment, the signal processing unit 12 is used to provide control signals for the laser transceiver assembly 11, the control assembly 13, and the power amplifier 14, and receive corresponding feedback signals.

The signal processing unit 12 is used to control the laser transceiver assembly 11 to emit a laser. The signal processing unit 12 controls the laser transceiver assembly 11 to emit a laser. The laser emitted by the laser transceiver assembly 11 is amplified by the power amplifier 14, enters the scanning module 20 through an optical fiber, passes through the optical path system in the scanning module 20, and exits from the window 300. The laser exiting to the outside of the housing 30 is reflected by an object to form an reflected signal. The reflected signal is reflected along the original path and enters the scanning module 20 from the window 300. After being reflected by the optical path system of the scanning module 20, the reflected signal is received by the laser transceiver assembly 11. In this embodiment, the laser emitted by the laser transceiver assembly 11 is a Frequency Modulated Continuous Wave (FMCW). Correspondingly, the LiDAR device 1 is an FMCW laser radar. Preferably, the laser is a 1550 nm wavelength beam.

The laser transceiver assembly 11 is also used to process the laser and the reflected signal to obtain an electrical signal and send the electrical signal to the signal processing unit 12. Specifically, the laser transceiver assembly 11 forms an electrical signal based on the interference of the laser and the reflected signal. The signal processing unit 12 is further used to receive the electrical signal sent by the laser transceiver assembly 11 and form point cloud data of the object based on the electrical signal. Specifically, the signal processing unit 12 processes and images the electrical signal to form point cloud data of the object.

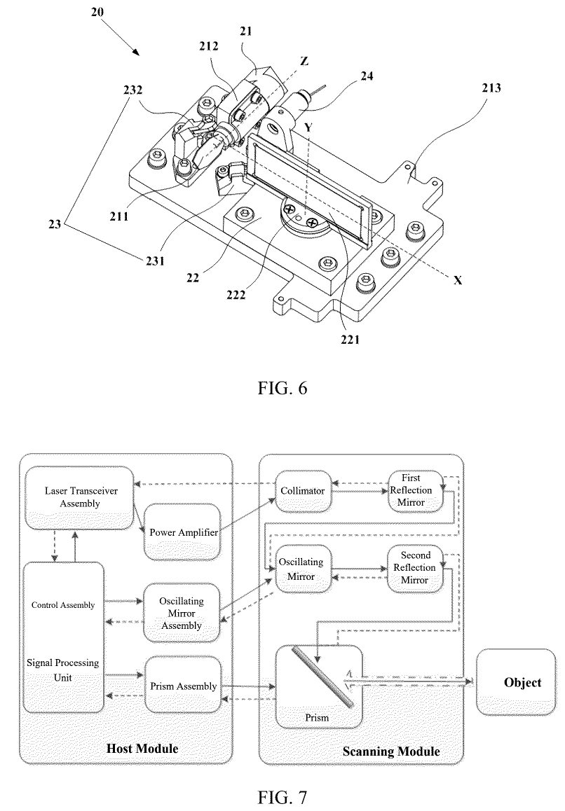

Referring to FIG. 6, which is a perspective view of a scanning module of the laser radar in accordance with an embodiment. The scanning module 20 includes an oscillating mirror assembly 21, a prism assembly 22, a reflection assembly 23, and a collimator 24. The collimator 24 is electrically connected to the laser transceiver assembly 11 and the power amplifier 14 respectively.

In this embodiment, the oscillating mirror assembly 21 includes an oscillating mirror 211 and an oscillating mirror motor 212. The oscillating mirror 211 is disposed on the oscillating mirror motor 212. The oscillating mirror motor 212 is used to drive the oscillating mirror 211 to oscillate. The prism assembly 22 includes a prism 221 and a prism motor 222. The prism 221 is disposed on the prism motor 222. The prism motor 222 is used to drive the prism 221 to rotate.

The control assembly 13 is electrically connected to the prism motor 222 and the oscillating mirror motor 212 respectively. The signal processing unit 12 is further used to control the control assembly 13 to generate drive signals and send them to the prism motor 222 and the oscillating mirror motor 212 respectively. In this embodiment, the control assembly 13 includes an oscillating mirror control board 131 and a prism control board 132. The oscillating mirror control board 131 is electrically connected to the signal processing unit 12 and the oscillating mirror motor 212 respectively. The prism control board 132 is electrically connected to the signal processing unit 12 and the prism motor 222 respectively. Both the oscillating mirror control board 213 and the prism control board 223 are circuit boards. The oscillating mirror control board 213 and the prism control board 223 are both provided with a plurality of electronic components for controlling the oscillating mirror motor 212 and the prism motor 222 respectively.

Specifically, the oscillating mirror motor 212 drives the oscillating mirror 211 to oscillate reciprocally within a preset angular range around a third axis Z. The prism motor 222 drives the prism 221 to rotate around a first axis Y. Among them, the third axis Z and the second axis X are perpendicular to each other. In this embodiment, the preset angular range is +6.25° to −6.25°. The prism motor 222 drives the prism 221 to perform a 360° rotational scanning motion around the first axis Y. Preferably, the prism 221 is a double-sided prism. In some feasible embodiments, the preset angular range can be set according to the actual detection requirements of the LiDAR device 1, which is not limited here.

The laser emitted by the laser transceiver assembly 11 is first incident on the oscillating mirror 211. After being reflected by the oscillating mirror 211, the laser is incident on the prism 221 along the second axis X. The lasers reflected by the oscillating mirror 211 are all located in the same plane, and the second axis X is located in the plane. Among them, the plane is perpendicular to the bottom wall of the housing 30. The lasers are all incident on the prism 221 along the plane. After being reflected by the prism 221, the lasers exit from the window 300 to the outside of the housing 30 and form two detection fields of view. Among them, the first axis Y and the second axis X are perpendicular to each other, and the second axis X is also perpendicular to the third axis Z. The reflecting surfaces of the oscillating mirror 211 and the prism 221 are both coated with a reflecting film. The reflectivity of the oscillating mirror 211 and the prism 221 to 1550 nm lasers is both greater than 90%.

In this embodiment, the detection fields of view include horizontal fields of view and vertical fields of view. The vertical field of view is formed by the reflection of the laser by the oscillating mirror 211. The horizontal field of view is formed by the reflection of the laser by the prism 221. Among them, since the oscillation range of the oscillating mirror 211 is +6.25° to −6.25°, the angle of the vertical field of view formed by the reflection of the oscillating mirror 211 is 25°. That is to say, the size of the preset angular range determines the size of the angle of the vertical field of view. Adjusting the size of the preset angular range can adjust the size of the angle of the vertical field of view. Therefore, the size of the angle of the vertical field of view is not limited to this. Since the side surface of the prism 221 cannot reflect the laser, the angle of the horizontal field of view formed by the reflection of the prism 221 is 160°. That is to say, the thickness of the prism 221 determines the size of the angle of the horizontal field of view. Adjusting the thickness of the prism 221 can adjust the size of the angle of the horizontal field of view. Therefore, the size of the angle of the horizontal field of view is not limited to this. It can be understood that the angle of the horizontal field of view of each detection field of view is 160°, and the angle of the vertical field of view is 25°.

In this embodiment, the two detection fields of view are symmetrical about the second axis X. It can be understood that since the prism 221 rotates 360° around the first axis Y, and the laser is incident on the prism 221 along the second axis X, when the prism 221 is rotated to be parallel to the second axis X, the laser is incident on the side surface of the prism 221 instead of the reflecting surface, and the side surface of the prism 221 cannot reflect the laser. Therefore, the reflection of the laser by the prism 221 can only form two detection fields of view that are symmetrical about the second axis X. Since the laser is incident on the prism 221 exactly along the second axis X, the angles between the two sides of the horizontal field of view of the detection fields of view and the second axis X are both 10°. If the direction of the laser incident on the prism 221 is set as 0°, then the horizontal fields of view of the two detection fields of view are +10° to +170° and +190° to +350° respectively. The two detection fields of view jointly form the detection field of view of the LiDAR device 1. The horizontal field of view angle of the detection field of view of the LiDAR device 1 is 320°, and the vertical field of view angle is 25°, so that the LiDAR device 1 has a large detection field of view. When the LiDAR device 1 is installed on a vehicle, it can effectively reduce the blind area of the vehicle.

The reflection assembly 23 includes a first reflection mirror 231 and a second reflection mirror 232. The collimator 24 is disposed opposite to the first reflection mirror 231. The oscillating mirror 211 is disposed on the reflection optical path of the first reflection mirror 231. The first reflection mirror 231 is used to reflect the laser emitted by the collimator 24 to the oscillating mirror 211. The second reflection mirror 232 is disposed on the reflection optical path of the oscillating mirror 211. The prism 221 is disposed on the reflection optical path of the second reflection mirror 232. The second reflection mirror 232 is used to reflect the laser reflected by the oscillating mirror 211 to the prism 221. The prism 221 is disposed opposite to the window 300. The prism 221 is used to emit the laser reflected by the second reflection mirror 232 from the window 300. Among them, the reflecting surfaces of the first reflection mirror 231 and the second reflection mirror 232 are both coated with a reflecting film. The reflectivity of the first reflection mirror 231 and the second reflection mirror 232 to 1550 nm lasers is both greater than 90%.

In this embodiment, the laser emitted by the laser transceiver assembly 11 is sent to the scanning module 20 through the power amplifier 14. The laser entering the scanning module 20 reaches the collimator 24. The collimator 24 sends the laser to the oscillating mirror 211. Specifically, the collimator 24 is disposed along a direction parallel to the third axis Z. The laser exiting from the collimator 24 is incident on the first reflection mirror 231 along a direction parallel to the third axis Z. The laser reflected by the first reflection mirror 231 is incident on the oscillating mirror 211 along a direction perpendicular to the third axis Z. The laser reflected by the oscillating mirror 211 is approximately incident on the second reflection mirror 232 along a direction parallel to the first axis Y. The laser reflected by the second reflection mirror 232 is approximately incident on the prism 221 along a direction perpendicular to the first axis Y. It can be understood that the laser is sequentially reflected by the first reflection mirror 231, the oscillating mirror 211, the second reflection mirror 232, and the prism 221 and exits to the outside of the housing 30. In this embodiment, the collimator 24 and the first reflection mirror 231 are disposed between the oscillating mirror 211 and the prism 221. The oscillating mirror 211 is adjacent to the collimator 24. The first reflection mirror 231 and the second reflection mirror 232 are located in the plane. Among them, the collimator 24, the first reflection mirror 231, the oscillating mirror 211, the second reflection mirror 232, and the prism 221 are compactly disposed, which can effectively reduce the volume of the scanning module 20 and make the LiDAR device 1 as a whole have the advantage of miniaturization.

The incident laser passes through the collimator 24 and is reflected by the first reflection mirror 231 to be incident on the oscillating mirror 211. The signal processing unit 12 controls the oscillating mirror control board 131 to generate a drive signal for the oscillating mirror motor 212. The oscillating mirror motor 212 receives the drive signal and drives the oscillating mirror 211 to oscillate around the third axis Z, so that the laser forms a vertical field of view. The laser is reflected by the second reflection mirror 232 to be incident on the prism 221. The signal processing unit 12 controls the prism control board 132 to generate a drive signal for the prism motor 222. The prism motor 222 receives the drive signal and drives the prism 221 to perform a 360°rotational scanning motion around the first axis Y, so that the laser forms a horizontal field of view. The laser exiting from the window 300 to the outside of the housing 30 is reflected by an object to form an reflected signal. The reflected signal is sequentially reflected by the prism 221, the second reflection mirror 232, the oscillating mirror 211, and the first reflection mirror 231 and is incident on the laser transceiver assembly 11.

In this embodiment, the housing 30 includes an upper shell and a lower shell that are connected. The host module 10 is fixedly mounted on the bottom wall of the lower shell. The scanning module 20 is disposed on a side of the host module 10 away from the lower shell. The scanning module 20 further includes an optical-mechanical structure base plate. The oscillating mirror assembly 21, the prism assembly 22, the reflection assembly 23, and the collimator 24 are all fixedly mounted on a side of the optical-mechanical structure base plate away from the host module 10. The prism 221 and the second reflection mirror 232 extend into the upper shell. Preferably, the upper shell is in the shape of a hollow cylinder as a whole.

The housing 30 is provided with two windows 300 that are symmetrical about the second axis X. The detection fields of view are in one-to-one correspondence with the windows 300. Specifically, the windows 300 are disposed on the side walls of the upper shell. In some feasible embodiments, the housing 30 is provided with one window 300. The window 300 is annular and surrounds the side walls of the upper shell.

In the above embodiments, the laser radar forms two detection fields of view through the rotation of the prism. The two detection fields of view jointly form the detection field of view of the laser radar. Based on the rotational scanning of a one-dimensional double-sided prism and the reciprocating oscillation of a one-dimensional oscillating mirror, the horizontal field of view of the detection field of view can reach 320°, and the vertical field of view of the detection field of view can reach 25°, so that the field of view of the laser radar's detection field of view reaches 320°x25°, featuring a large field of view. When applied in the field of autonomous driving, the laser radar is installed on the vehicle and can detect a large area around the vehicle, making the vehicle's field of view blind area smaller and thus increasing the safety factor of autonomous driving.

In addition, the laser radar is a hybrid solid-state laser radar, which has the advantages of small moment of inertia, simple structure, high reliability, easy integration, and miniaturization, and has good development prospects in the field of vehicle-mounted laser radars.

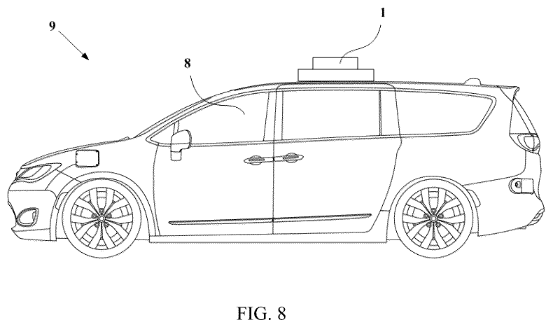

Referring to FIG. 8, which is a schematic view of a vehicle in accordance with an embodiment. The vehicle 9 includes a body 8 and a LiDAR device 1. Among them, the specific structure of the LiDAR device 1 refers to the above embodiments.

In this embodiment, the LiDAR device 1 is disposed on the body 8. Preferably, the LiDAR device 1 is installed on the roof of the body 8, so that the LiDAR device 1 can detect the front of the vehicle 9 while also detecting the left and right sides and the rear of the vehicle 1. That is to say, the LiDAR device 1 can detect a 360° range around the vehicle 9, thereby avoiding blind areas, increasing the safety factor of the vehicle 1, and improving the safety of the vehicle 1 during driving. In some feasible embodiments, the position where the LiDAR device 1 is installed on the body 8 can be set according to actual detection requirements, which is not limited here.

Since the vehicle 9 adopts all the technical solutions of all the above embodiments, the vehicle 9 at least has all the beneficial effects brought by the technical solutions of the above embodiments, which will not be repeated here one by one.

Obviously, those skilled in the art can make various modifications and variations to the disclosure without departing from the spirit and scope of the disclosure. Therefore, if these modifications and variations of the disclosure fall within the scope of the claims of the disclosure and their equivalent technologies, the disclosure also intends to include these modifications and The above-listed are merely preferred embodiments of the disclosure, and of course, cannot be used to limit the scope of the claims of the disclosure. Therefore, equivalent changes made according to the claims of the disclosure still fall within the scope covered by the disclosure.

1. A LiDAR device, comprising:
a housing, including a laser transceiver assembly;
a host module, and
a scanning module, comprising a prism rotating about a first axis;
wherein both the host module and the scanning module are disposed within the housing, the laser emitted by the laser transceiver assembly is incident to the prism along a second axis, the laser is reflected and emitted out of the housing by the prism, forming two detection fields of view, the first axis and the second axis are perpendicular to each other, and the two detection fields of view are symmetrical about the second axis.

2. The LiDAR device according to claim 1, wherein the scanning module further comprises:
an oscillating mirror assembly, comprising oscillating mirror configured to oscillate about a third axis; and
a reflecting assembly, comprising a first reflecting mirror, and a second reflecting mirror;
wherein:
the third axis is perpendicular to the second axis;
the oscillating mirror is disposed on a reflection optical path of the first reflecting mirror;
the second reflecting mirror is disposed on a reflection optical path of the oscillating mirror;
the prism is disposed on a reflection optical path of the second reflecting mirror, such that the laser beam is sequentially reflected by the first reflecting mirror, the oscillating mirror, the second reflecting mirror, and the prism before exiting the housing.

3. The LiDAR device according to claim 2, the laser beam reflected by the oscillating mirror travels within a single plane, and the second axis lies entirely within and is parallel to the plane; the detection fields of view comprise a horizontal field of view and a vertical field of view, wherein the oscillating mirror scans the laser beam along a first direction to form the vertical field of view, and the prism scans the laser beam along a second direction orthogonal to the first direction to form the horizontal field of view.

4. The LiDAR device according to claim 2, wherein the scanning module further comprises a collimator disposed opposite to the first reflecting mirror, the collimator is electrically coupled to the laser transceiver assembly to collimate the laser beam emitted from the laser transceiver assembly, wherein the collimated laser beam is directed from the collimator to the first reflecting mirror along a direction parallel to the third axis.

5. The LiDAR device according to claim 2, wherein the laser emitted out of the housing is reflected by an object to form an reflected signal; the reflected signal travels along a reverse optical path through the prism, the second reflecting mirror, the oscillating mirror, and the first reflecting mirror to be received by the laser transceiver assembly.

6. The LiDAR device according to claim 5, wherein the host module further comprises a signal processing unit electrically connected to the laser transceiver assembly, the signal processing unit is configured to:
control the laser transceiver assembly to emit the laser signal;
receive the electrical signal from the laser transceiver assembly, and
form point cloud data of the object according to the electrical signal.

7. The LiDAR device according to claim 6, wherein the scanning module further comprises:
a prism assembly, including:
a prism motor; and
the prism, mounted on the prism motor;
wherein the prism motor is configured to drive the prism to continuously through 360 degrees about the first axis; and
the oscillating mirror assembly, further including:
a oscillating mirror motor, mounted on the oscillating mirror motor;
wherein the oscillating mirror motor is configured to drive the oscillating mirror to oscillate within a predetermined angular range about the third axis.

8. The LiDAR device according to claim 7, wherein the host module further comprises:
a control assembly, electrically coupled to the signal processing unit, the prism motor, and the oscillating mirror motor; the signal processing unit is further configured to control the control assembly to generate a drive signal and transmit the drive signal to the prism motor and the oscillating mirror motor.

9. The LiDAR device according to claim 1, wherein the housing comprises two windows symmetrical about the second axis, and the detection fields of view are in one-to-one correspondence with the windows.
a vehicle body; and
a LiDAR device comprising:
a housing, including a laser transceiver assembly;
a host module, and
a scanning module, comprising a prism rotating about a first axis;
wherein both the host module and the scanning module are disposed within the housing, the laser emitted by the laser transceiver assembly is incident to the prism along a second axis, the laser is reflected and emitted out of the housing by the prism, forming two detection fields of view, the first axis and the second axis are perpendicular to each other, and the two detection fields of view are symmetrical about the second axis.

11. The vehicle according to claim 10, wherein the scanning module further comprises:
an oscillating mirror assembly, comprising oscillating mirror configured to oscillate about a third axis; and
a reflecting assembly, comprising a first reflecting mirror, and a second reflecting mirror;
wherein:
the third axis is perpendicular to the second axis;
the oscillating mirror is disposed on a reflection optical path of the first reflecting mirror;
the second reflecting mirror is disposed on a reflection optical path of the oscillating mirror;
the prism is disposed on a reflection optical path of the second reflecting mirror, such that the laser beam is sequentially reflected by the first reflecting mirror, the oscillating mirror, the second reflecting mirror, and the prism before exiting the housing.

12. The vehicle according to claim 11, the laser beam reflected by the oscillating mirror travels within a single plane, and the second axis lies entirely within and is parallel to the plane; the detection fields of view comprise a horizontal field of view and a vertical field of view, wherein the oscillating mirror scans the laser beam along a first direction to form the vertical field of view, and the prism scans the laser beam along a second direction orthogonal to the first direction to form the horizontal field of view.

13. The vehicle according to claim 11, wherein the scanning module further comprises a collimator disposed opposite to the first reflecting mirror, the collimator is electrically coupled to the laser transceiver assembly to collimate the laser beam emitted from the laser transceiver assembly, wherein the collimated laser beam is directed from the collimator to the first reflecting mirror along a direction parallel to the third axis.

14. The vehicle according to claim 11, wherein the laser emitted out of the housing is reflected by an object to form a reflected signal; the reflected signal travels along a reverse optical path through the prism, the second reflecting mirror, the oscillating mirror, and the first reflecting mirror to be received by the laser transceiver assembly.

15. The vehicle according to claim 14, wherein the host module further comprises a signal processing unit electrically connected to the laser transceiver assembly, the signal processing unit is configured to:
control the laser transceiver assembly to emit the laser signal;
receive the electrical signal from the laser transceiver assembly, and
form point cloud data of the object according to the electrical signal.

16. The vehicle according to claim 15, wherein the scanning module further comprises:
a prism assembly, including:
a prism motor; and
the prism, mounted on the prism motor;
wherein the prism motor is configured to drive the prism to continuously through 360 degrees about the first axis; and
the oscillating mirror assembly, further including:
a oscillating mirror motor, mounted on the oscillating mirror motor;
wherein the oscillating mirror motor is configured to drive the oscillating mirror to oscillate within a predetermined angular range about the third axis.

17. The vehicle according to claim 16, wherein the host module further comprises:
a control assembly, electrically coupled to the signal processing unit, the prism motor, and the oscillating mirror motor; the signal processing unit is further configured to control the control assembly to generate a drive signal and transmit the drive signal to the prism motor and the oscillating mirror motor.

18. The vehicle according to claim 10, wherein the housing comprises two windows symmetrical about the second axis, and the detection fields of view are in one-to-one correspondence with the windows.
